(19) United States
(12) Patent Application Publication
(10) Pub. No.: US 2005/0207617 A1
(43) Pub. Date: Sep. 22, 2005

(54) Digital representation of a live event

(76) Inventor: Tim Sarnoff, Westlake Village, CA (US)

Correspondence Address: FROMMER LAWRENCE & HAUG, 745 FIFTH AVENUE- 10TH FL., NEW YORK, NY, 10151, US

(21) Appl. No.: 11/018,082

(22) Filed: Dec. 20, 2004

Related U.S. Application Data
(60) Provisional application No. 60/550,026, filed on Mar. 3, 2004.

(51) Int. Cl. G06K 9/00; G06K 9/36; H04B 7/185

(52) U.S. Cl. 382/103; 382/154; 342/357.01

(57) ABSTRACT

Methods and apparatus for implementing a system for building a digital representation of captured motion, such as from a live event. In one implementation, a representation system includes: a marker to emit a signal indicating marker information; a receiver to receive said signal from said marker; a data collector, connected to said receiver, to store said marker information; and a model generator, connected to said data collector, to generate a position model using said stored marker information.

This application claims the benefit of U.S. Provisional Application No. 60/550,026, filed Mar. 3, 2004, the disclosure of which is incorporated herein by reference.

### BACKGROUND

A tagging or motion capture system typically provides capturing and recording the fine motor movements of an actor's body to build a digital representation of the actor, such as for a computer graphics (CG) model. One typical system is a light reflecting system using multiple light reflective balls or bulbs (as many as 150 or more) as tags attached to the actor's face and body and multiple cameras that surround the individual. Using the cameras to capture the motion of the tags through light reflected by the tags from a light source, the system builds data reflecting the location and motion of the tags. This type of system is typically designed to be used in a controlled stage environment, with controlled lighting and distance between the cameras and actors. Accordingly, these systems are generally used for capturing the motion of a specific individual in a staged situation, rather than a live event.

### SUMMARY

The present invention provides methods and apparatus for implementing a system for building a digital representation of captured motion, such as from a live event. In one implementation, a representation system includes: a marker to emit a signal indicating marker information; a receiver to receive said signal from said marker; a data collector, connected to said receiver, to store said marker information; and a model generator, connected to said data collector, to generate a position model using said stored marker information.

In another implementation, a method of generating a model representing motion of a marker includes: receiving from a marker a marker signal indicating marker information; storing said marker information; and generating a position model using said stored marker information; wherein said position model indicates the position of said marker at the time said signal was received.

### BRIEF DESCRIPTION OF THE DRAWINGS

FIG. 1 shows an illustration of one implementation of a representation system.

FIG. 2 shows a block diagram of one implementation of a representation system.

FIG. 3 shows a representation of a process of generating an image from collected marker information during a live event according to one implementation.

FIG. 4 shows a flow chart of one implementation of generating a representation of a live event.

FIG. 5 shows a flow chart of one implementation of building a model for a representation of a live event.

### DETAILED DESCRIPTION

The present invention provides methods and apparatus implementing a system for building a digital representation of a live event. In one implementation, the system is a computer system that uses a motion or position capture system to record the motion of a collection of markers over time and build a model from that recorded data. Using the model, the digital representation of a live event can be presented to viewers and accessed as data, such as for use in presentations and video games. In other implementations, some or all of the data can be stored or used as non-digital information as well.

Live events, such as sports competitions, are typically recorded as video. Using a motion capture system the event could be recorded as data and a digital model or representation of that event can be built. The model could then be used, for example, to provide multiple views of an event by generating a video representation of the model from a particular point of view using a computer system. Depending upon the type of markers used, the motion can be captured without using cameras.

Several illustrative examples of implementations are presented below. These examples are not exhaustive and additional examples and variations are also described later.

In one example, a radio-based motion capture system collects data for a representation of a football game. The capture system uses RF (radio frequency) tags as markers, such as typical RFID tags (as discussed below, other types of markers can be used). The markers are passive transponders and emit radio signals in response to received radio signals (alternatively, active markers can be used that periodically emit radio signals). The emitted signals are used to determine the location and the identity of the marker, such as by using respective wavelengths or identifying codes. Receivers receive the signals from the markers and the system determines and records the location and movement of the markers to build the model (e.g., using GPS information, triangulation and/or time differential information to determine location).

The markers are attached to or embedded in the objects in the football game, such as to or in the players' uniforms, the ball, and the referee(s). The location and movements of these objects can then be captured by recording the location and movements of the markers. From the captured data, a digital model can be built, such as a three-dimensional representation (e.g., using defined three-dimensional models of objects/people placed at the recorded positions). Over time, the digital model represents the activity in the game. The digital model is provided to a presentation device, such as over the Internet or as part of or along with a radio or broadcast signal (e.g., for television or cellular phone), or stored on removable media (e.g., an optical disc). The presentation device presents the digital model to a viewer, such as through a television connected to a game console or computer system. The viewer could then manipulate the viewpoint in the model to view the model from a user selected viewpoint. Each viewer can create a “personal camera.” Similarly, each viewer could manipulate the model in time, such as pausing, slowing, reversing, replaying, advancing, etc. For example, a viewer could view a slowed replay of a play in a game from the point of view of the referee. A user could also store the model or parts of the model for later viewing. A user could then build a library of favorite plays or games. This presentation of models provides another application of a game console as a data presentation device, using the powerful graphics capabilities of video game systems for presenting and manipulating a digital model.

While this example refers to a football game, the types of events are not limited to football games and could include other team sports (such as basketball or baseball, or children's sports), individual sports (such as golf, boxing, skiing, or auto racing), multi-game events (such as the Olympics), or non-sporting events (such as live theater, a speech, a debate, a presentation or training demonstration, or a concert). Similarly, the capture and representation can be applied to other types of live data, such as capturing the movement of auto traffic or inventory items to build an image representing the location and movement of these objects.

If the number of markers used to capture the live event is small, the specific model for each of the objects (e.g., the specific players) could be built separately, such as in a stage setting before the live event. The captured motion of the live event can then be applied to the specific models to build the representation. That application could occur at the system level or at the presentation device level. In another example, a user could select the models to use, such as using a themed-set of models (e.g., movie characters) to represent players in a game, or using selected car models to represent cars in a race. As a result, different users could view different images based upon the same model.

In one example, the system uses a single marker for each object, such as embedding a marker in each player's helmet and one marker in the ball. In this case, the specific motions of the character model are generated according to a character model and logic defined separately from the captured motion or position data. In another example, the single maker for a player is in the shoe of the player to track the motion of the player's foot. Alternatively, two markers can be used—one for each foot. The representation system animates a corresponding model for the person or object according to the captured movement based on the relationship of the position of the marker(s) to the person or object as a whole.

Other aspects of the model that are not part of the captured data can also be separately generated. For example, the venue (e.g., stadium), the environment (e.g., weather), the fans, etc. These additional models or data can be separately downloaded to the presentation device, such as through separate purchases of media.

In another example, the captured model is used as data for a video game. The game software would present the game using the model and the player could interject actions or events to alter the game. The game software would adapt the model (or drop the model and continue as a normal computer controlled game) to reflect predicted effects of the player's action and proceed with the game. In this way a user can experiment with different events in the game, such as changing a particular defensive formation at a key play in the game.

Portions of the model can also be used by game software for later games. For example, a particular offensive formation of players and their motion during the play can be stored as a play or formation to be used by a player during a video game. A motion sequence for a player could be captured and used as a stock sequence throughout the game.

The model could also be altered by the player. For example, a user could add a player or competitor, such as adding a runner to the race. The added player could be a computer generated player or one built or developed by the user (through playing the video game). Using recording equipment (such as a camera) the user could add a representation of the actual user to the model.

These examples illustrate many interesting aspects of using captured motion information to build a digital representation of the live event or live action. This powerful combination provides an enjoyable way for a user to enhance the viewing and interactive experience with an event. In addition, a system can build a representation of object motion in an environment where visual tracking of objects using cameras would be difficult or inconvenient.

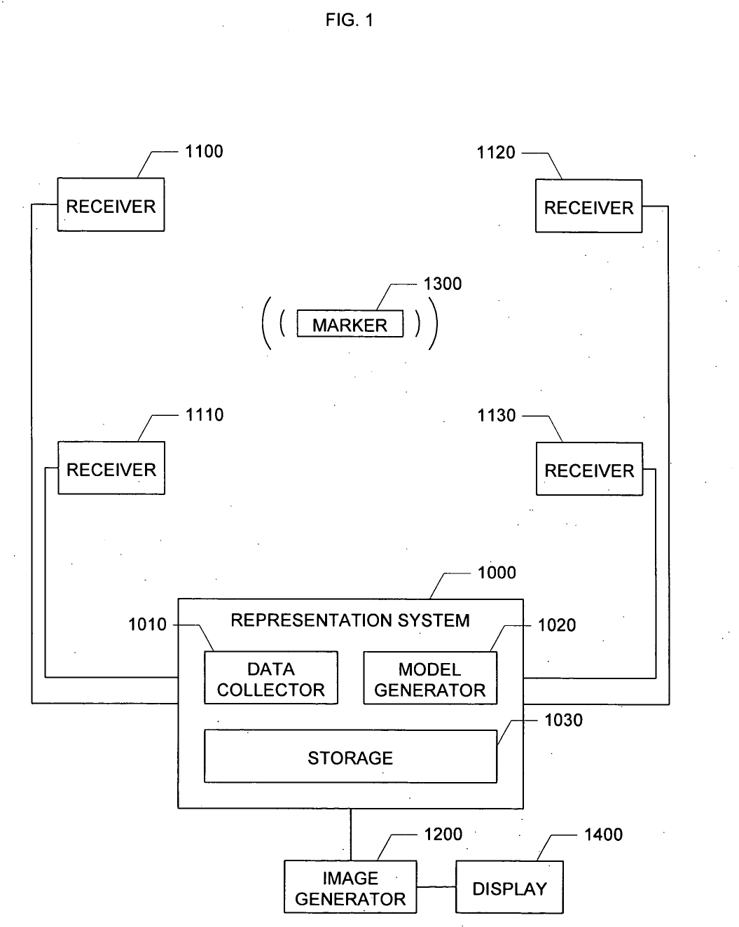

FIG. 1 shows an illustration of one implementation of a representation system. A representation system 1000 is connected to four receivers 1100, 1110, 1120, 1130 and an image generator 1200. A marker 1300 is positioned between the receivers 1100, 1110, 1120, 1130. A display device 1400 is connected to the image generator 1200.

The marker 1300 is a small portable or embedded device that emits radio signals including marker information. In one implementation, the marker 1300 is an active radio device, and periodically transmits radio signals. In another implementation, the marker 1300 is a passive radio device, and transmits radio signals in response to receiving a radio signal. The marker 1300 can be affixed to or embedded in a target, such as in an object or a person's clothing. In one implementation, the marker 1300 is a radio frequency identification (RFID) tag. In another implementation, the marker 1300 emits signals using a different mode. Examples of alternative signals include, but are not limited to: electromagnetic radiation at any or a combination of various frequencies (e.g., audible or inaudible sound or visible or invisible light), an electric or magnetic field, or a particle emitting or chemical marker. In one implementation, the marker performs a different primary function than acting as a marker for motion capture. For example, the signals of a mobile phone can be used to treat the phone as a marker (similarly, the corresponding base stations can act as receivers and the phone system shares the information with the representation system). In FIG. 1, a single marker is shown, however, in various implementations and applications, multiple markers can be used.

The receivers 1100, 1110, 1120, 1130 are radio signal receivers to receive the radio signals emitted by the marker 1300. Accordingly, the receivers 1100, 1110, 1120, 1130 each include antennas, filters, and other appropriate radio reception components. The receivers 1100, 1110, 1120, 1130, provide the radio signals or corresponding derived information to the representation system 1000. In one implementation, a receiver includes data processing components to generate reception information regarding received radio signals, such as time of reception or signal strength. The receivers 1100, 1110, 1120, 1130 provide the reception information to the representation system 1000 (instead of or in addition to the radio signals). In another implementation, one or more of the receivers are integrated with the representation system. In FIG. 1, four receivers are shown, however, in various implementations and applications, more or less receivers can be used.

In an implementation using passive radio markers, one or more of the receivers 1100, 1110, 1120, 1130 is a transceiver and includes transmission components to send a radio signal to the passive markers. When a passive marker receives the signal from a transceiver, the incoming signal causes the passive marker to emit a response (e.g., as a transponder). Alternatively, one or more separate transmitters can be used.

The representation system 1000 includes components implementing a data collector 1010, a model of a generator 1020, and storage 1030. In one implementation, the representation system 1000 is a computer system, and the data collector 1010 and the model generator 1020 are implemented as software systems executing upon the representation system 1000. The data collector 1010 receives data from the receivers 1100, 1110, 1120, 1130 and determines the position of the marker 1300. The model generator 1020 uses position information generated by the data collector 1010 to generate a model representing the position and movement of the marker 1300 over time. The storage 1030 stores data received from the receivers 1100, 1110, 1120, 1130 and data generated by the data collector 1010 and the model generator 1020.

In one implementation, the position model provides information indicating the position of the marker in a series of discrete points in time, such as representing frames of video. In another implementation, the position model also provides information indicating the position of other objects not represented by markers but included within the model. For example, in a model for a football game, the position model indicates the positions of objects representing parts of the stadium and field (e.g., sidelines, goalposts, seats, etc.) and additional people (e.g., spectators, cameramen, referees, etc.). In another implementation, the model generator 1020 uses the position model to build a three-dimensional model representing the live event (e.g., a surface model). For example, in a model for a football game, where one marker is attached to one player, the model generator 1020 builds a three-dimensional surface model of the football player over time based upon the position and movement of the marker represented by the position model. In this case, the representation system 1000 stores additional information indicating the configuration and movement parameters of the objects corresponding to markers for which position data is being captured. For example, when the marker is attached to the chest of the football player's uniform, and as the football player moves across the field, the model generator 1020 updates the surface model to reflect the animation of the body, limbs, and equipment defined for the football player. This process is similar to the process of animating a football player in a football video game (e.g., building a surface model or wire frame model from position information and context, such as previous movement and other objects), except that at least some of the positions are determined by captured position data from an actual live event rather than purely computer-generated position information. Alternatively, multiple markers are used for a player (e.g., one for each foot, or one for each limb). In another implementation, the model generator 1020 provides the position model to the image generator 1200 and the image generator 1200 builds a surface model. Any or all of a position model, a three-dimensional model, or a surface model can act as digital representations of the live event.

The image generator 1200 generates an image for display using a model received from the representation system 1000. In one implementation, the image generator 1200 is a computer system, such as a desktop PC or a game console. The image generated is a digital representation of an image, such as a frame of pixels. The image generator 1200 renders pixels based upon the position of objects indicated by the position model and the defined characteristics of those objects (e.g., as in video game rendering). As described above, in one implementation, the image generator 1200 builds or receives a surface model reflecting the configuration of objects corresponding to positions in the position model. The image generator 1200 renders pixels based upon the surface model, similar to typical computer animation using surface characteristics, lighting, and a selected camera angle for presenting the image. By generating a series of images over a range of time, a video image can be created. The image generator 1200 generates 1200 generates the image in real-time or can pre-render a series of images and store the sequence (e.g., for later viewing or distribution). The generated image sequence can also act as a digital representation of the live event.

The image generator 1200 receives the model information from the representation system 1000 through a network connection (e.g., a wired Ethernet connection) or as data stored on removable media inserted into the image generator 1200 (e.g., stored on an optical disc inserted into an optical disc drive). In one implementation, the image generator 1200 also includes digital to analog conversion components to produce analog signals to drive an analog display device. In another implementation, the image generator 1200 is integrated with the representation system 1000.

Upon request, the image generator 1200 can re-render images from the same model using different parameters. For example, a user can request that the camera position move. In response, the image generator 1200 generates a new image for the new camera position and angle. In this way, the user can move the camera and viewing position for a model freely and enjoy viewing a live event from any desired angle. Similarly, the user can request other image changes, such as brightness, color, zoom, etc., or special effects, such as highlighting or removing particular players or objects.

The generated image does not have to correspond directly in appearance to the actual actors/objects in the live event. For example, the movement of a group of people can be captured and the resulting image is a two-dimensional view of dots moving in an area or the image can show the people as fanciful creatures (e.g., animals, monsters, etc.).

The display device 1400 is a typical image or a video display devices (analog or digital), such as a television or monitor. In another implementation, the display device 1400 is integrated with the image generator 1200 or the representation system 1000.

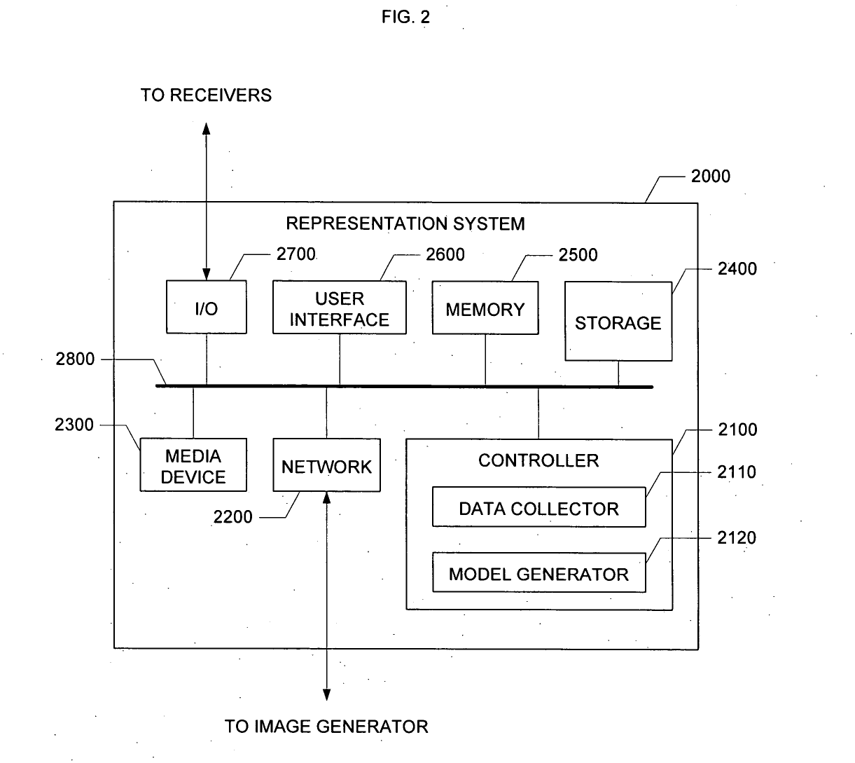

FIG. 2 shows a block diagram of one implementation of a representation system 2000 (e.g., implementing the representation system 1000 shown in FIG. 1). The representation system 2000 includes a controller 2100, a network interface 2200, a media device 2300, storage 2400, memory 2500, a user interface 2600, and an I/O interface 2700. The components of the representation system 2000 are interconnected through a common bus 2800.

The controller 2100 is a programmable processor and controls the operation of the representation system 2000 and its components. The controller 2100 loads instructions from the memory 2500 or an embedded controller memory (not shown) and executes these instructions to control the system. In its execution, the controller 2100 provides two services as software systems: a data collector service 2110, and a model generator service 2120. Alternatively, either or both of these services can be implemented as separate components in the representation system 2100. The data collector service 2110 and the model generator service 2120 can implement the data collector 1010 and the model generator 1020 shown in FIG. 1. The data collector 2110 receives, stores, and analyzes signals and/or data received from one or more receivers to determine the position of one or more markers. The data collector 2110 stores the position information in the storage 2400′. The model generator 2120 uses the position information generated by the data collector 2110 to build a model representing the position and movement of the marker(s) overtime. As described above, in one implementation, the model generator 2120 builds a position model and a surface model.

The network interface 2200 includes a wired and/or wireless network connection, such as an RJ-45 or “Wi-Fi” interface (802.11) supporting an Ethernet connection. The network interface 2200 is connected to an image generator (e.g., the image generator 1200 shown in FIG. 1). The controller 2100 sends model information to the image generator through the network interface 2200.

The media device 2300 receives removable media and reads and/or writes data to the inserted media. In one implementation, the media device 2300 is an optical disc drive. In one implementation, the representation system 2000 stores a position model (and/or a surface model) on an article of writable media in the media device 2300 and provides the model to the image generator through distribution of that media.

Storage 2400 stores data temporarily or long term for use by the other components of the representation system 2000, such as for storing marker information and models. In one implementation, storage 2400 is a hard disk drive.

Memory 2500 stores data temporarily for use by the other components of the representation system 2000. In one implementation, memory 2500 is implemented as RAM. In one implementation, memory 2500 also includes long-term or permanent memory, such as flash memory and/or ROM.

The user interface 2600 includes components for accepting user input from a user of the representation system 2000 and presenting information to the user. In one implementation, the user interfaces 2600 includes a keyboard, a mouse, audio speakers, and a display. The controller 2100 uses input from the user to adjust the operation of the representation system 2000.

The I/O interface 2700 includes one or more I/O ports to connect to corresponding receivers (e.g., the receivers 1100, 1110, 1120, 1130 shown in FIG. 1). Alternatively a single port is used for multiple receivers, such as a network port. The representation system 2000 communicates with the receivers through the I/O interface 2700. In one implementation, the ports of the I/O interface 2700 are RJ-45 connectors. In another implementation, the I/O interface 2700 can be a wireless interface for communication with multiple receivers wirelessly.

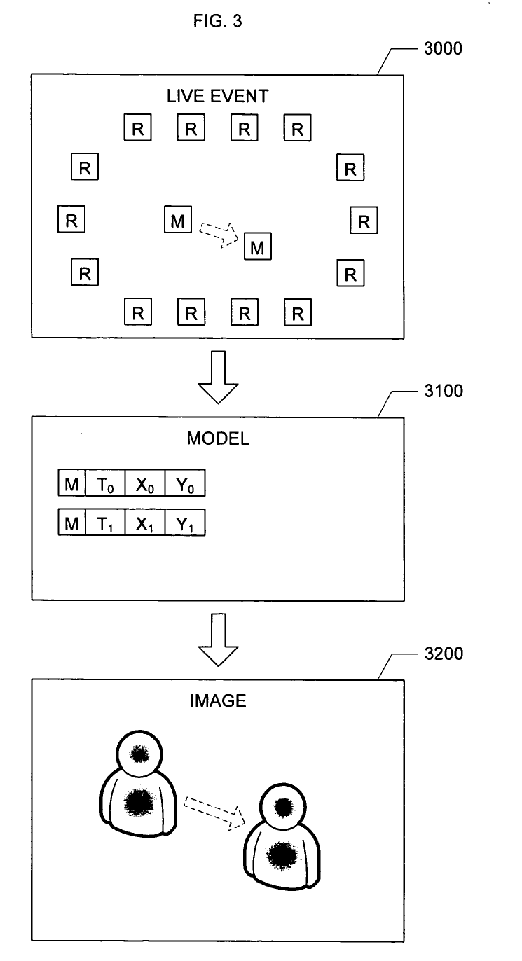

FIG. 3 shows a representation of a process of generating an image from collected marker information during a live event according to one implementation. The process includes three broad phases: collecting marker information in the first phase 3000, building a model in the second phase 3100, and generating an image in the third phase 3200. In the first phase 3000, during a live event (e.g. a sporting event), a marker moves from one position to another. The marker periodically sends signals to the surrounding receivers. In FIG. 3, the marker in the first phase 3000 is indicated by M, and the receivers are indicated by R. As shown in FIG. 3, the marker moves about in an area surrounded by receivers. The receivers pass the information from the marker to a representation system (not shown). In the second phase 3100, the representation system builds a position model reflecting the changes of the position of the marker over time. In FIG. 3, in the second phase 3100, two entries from a position table or database in the representation system are shown reflecting the X-Y position of the marker M at times T0 and T1. The representation uses these entries in the position model (e.g., creating entries for all the time units for all the objects to be tracked in the model and shown in the resulting image). In the third phase 3200, an image generator generates an image reflecting the movement of the marker based on the changes in position information shown in the generated model. These three phases are repeated during the recording period of the live event. Accordingly, as the marker moves and changes position, these changes are captured by the receivers and incorporated into the position model built by the representation system. The resulting image reflects the movement of the marker through the changes in the position model. By constantly updating the model with new captured information, the image can reflect the ongoing changes in the event.

In FIG. 3, a single marker is shown. In implementations and applications using multiple markers, the position and movement information of the multiple markers is captured to the receivers and stored in the position model. The position model reflects the position and movement of all of the markers being tracked by the representation system. The combined position model provides the information to generate an image reflecting the position and movement of all of the object's being tracked.

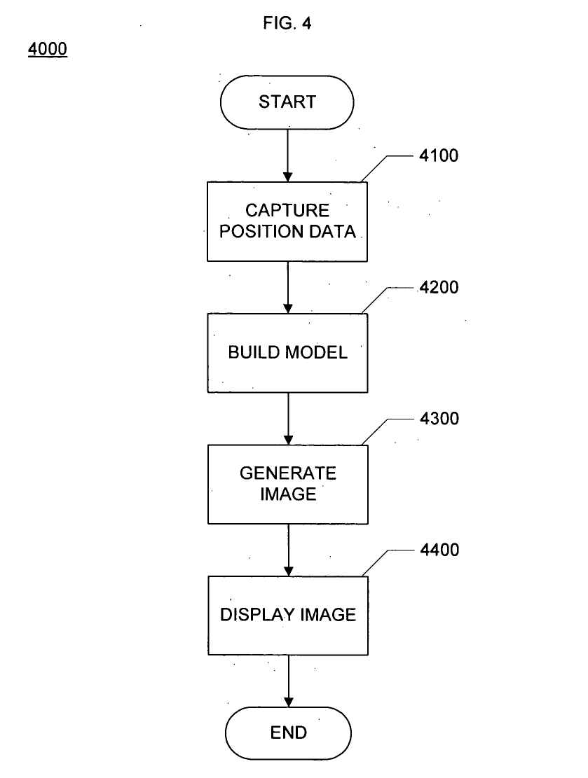

FIG. 4 shows a flow chart 4000 of one implementation of generating a representation of a live event. Initially, one or more markers are positioned between multiple receivers (or within range of a single receiver) connected to a representation system. The markers send signals carrying marker information that uniquely identify each marker, such as identification codes. Alternatively, different markers use different modes, such as respective frequencies.

The representation system captures position information for each of the markers, block 4100. The receivers connected to the representation system receive the signals emitted from the markers. The representation system builds a model representing the positions of the markers, block 4200. The representation system uses the captured marker information to build a model of the positions of the markers over time. The representation system generates an image representing the recorded positions, block 4300. The representation system uses the position model to determine where an object represented by a marker is and then uses object information to build an image of that object. The representation system builds a complete image by compiling the images for captured objects and images for any added objects as well. The representation system displays the image, block 4400. The representation system repeats this process throughout the live event, repeatedly updating the model and generating corresponding images. By building a series of images over time, the representation system generates a video image representing the movement of objects as indicated by marker motion captured by the receivers.

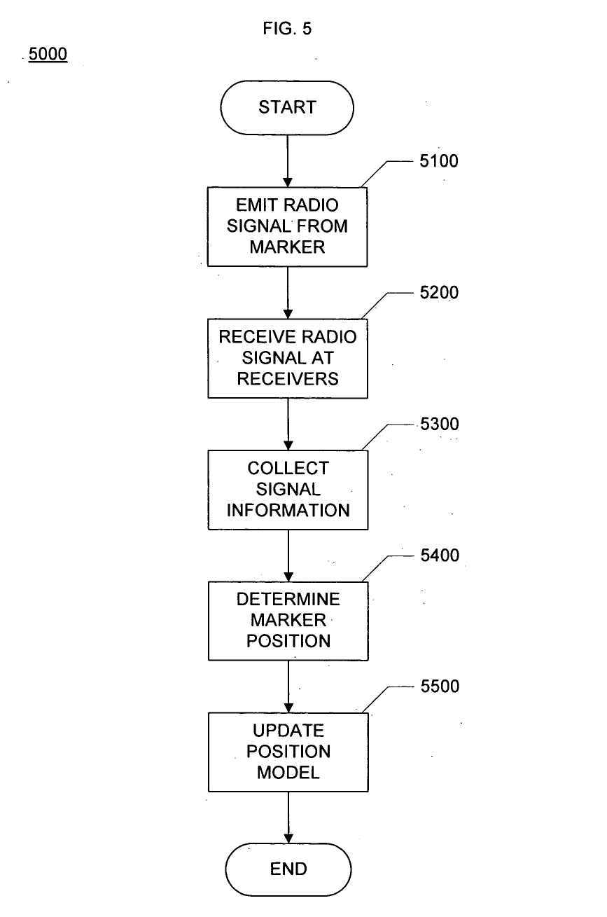

FIG. 5 shows a flow chart 5000 of one implementation of building a model for a representation of a live event. Initially, one or more radio markers are positioned between multiple receivers connected to a representation system.

Each marker emits a radio signal, block 5100. The markers are active radio markers, each periodically emitting radio signals identifying the marker (e.g., 60 or 30 times per second). The radio signal includes marker information uniquely identifying each marker (e.g., as data modulated upon the radio signal). In another implementation, the marker information includes position information specifically indicating the current position of the marker in three dimensions (e.g., GPS information). The markers do not necessarily all send signals at the same time.

The receivers connected to the representation system receive the radio signals emitted from the markers, block 5200. Not every receiver necessarily receives a signal from each marker. The receivers digitize the received radio signals. The receivers extract the marker information from the digitized signals and pass the information to the reception system.

The representation system collects the captured information, block 5300. The representation system builds and updates a database of position and marker information. The representation system stores the information for each of the markers with a corresponding time stamp to indicate at what time the receiver received the stored information from a particular marker.

The representation system determines the position of each marker for a particular time, plot 5400. In one implementation, the representation system determines the position of a marker using the known positions of receivers and the times when different receivers received the same signal from a particular marker. For example, the representation system compares the reception times for signals having corresponding marker identifiers. In another implementation, the representation system uses variations in signal strength to estimate marker position. In another implementation, the marker information includes specific position information (e.g., GPS information).

The representation system updates a position model representing the position and movement of the markers over time, block 5500. For a unit of time (e.g., 1/60 of one second), the representation system creates or updates a database entry for each marker indicating the position of that marker at that time. As a result, the representation system stores the position of each marker at each point in time during a recorded event. As described above, the representation system uses the position model to generate an image representing the position of the markers and corresponding objects. Using a series of images, the representation system builds a moving image showing the movement of the markers over time.

The various implementations of the invention are realized in electronic hardware, computer software, or combinations of these technologies. Most implementations include one or more computer programs executed by a programmable computer. For example, in one implementation, the representation system for building a digital representation includes one or more computers executing software implementing the identification processes discussed above. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description describes motion capture of data using radio markers, in other implementations other types of markers can be used, such as electric, magnetic, audio (e.g., sonar, ULF, UHF etc.), or light (e.g., visible, ultraviolet or infrared). Similarly, the examples above focus on sports (a football game), but other live events can also be captured and represented (such as a ballet performance or traffic simulation).

Accordingly, the present invention is not limited to only those implementations described above.

1. A representation system, comprising:
a marker to emit a signal indicating marker information;
a receiver to receive said signal from said marker;
a data collector, connected to said receiver, to store said marker information; and
a model generator, connected to said data collector, to generate a position model using said stored marker information.

2. The representation system of claim 1, wherein:
said signal is emitted using electromagnetic radiation.

3. The representation system of claim 2, wherein:
said signal is a radio signal.

4. The representation system of claim 1, wherein:
said signal is a magnetic signal.

5. The representation system of claim 1, wherein:
said marker information includes position information indicating the position of said marker.

6. The representation system of claim 5, wherein:
said position information is GPS information.

7. The representation system of claim 1, wherein:
said marker information includes identification information identifying said marker.

8. The representation system of claim 1, further comprising:
at least one additional marker, each additional marker emitting a respective signal indicating respective marker information.

9. The representation system of claim 1, further comprising:
at least one additional receiver.

10. The representation system of claim 1, wherein:
each of multiple receivers generates respective reception information based on receiving said signal;
said data collector receives reception information from at least two receivers;
said data collector determines a position of said marker using said received reception information.

11. The representation system of claim 10, wherein:
said reception information indicates when the receiver received the signal.

12. The representation system of claim 10, wherein:
said reception information indicates the signal strength of the received signal.

13. The representation system of claim 1, wherein:
said data collector determines a position of said marker using said marker information.

14. The representation system of claim 1, wherein:
said receiver generates reception information based on receiving said signal,
said data collector determines a position of said marker using said reception information.

15. The representation system of claim 14, wherein:
said reception information indicates when the receiver received the signal.

16. The representation system of claim 14, wherein:
said reception information indicates the signal strength of the received signal.

17. The representation system of claim 1, wherein:
said position model indicates the position of said marker over time.

18. The representation system of claim 1, wherein:
said position model is a three-dimensional model.

19. The representation system of claim 1, further comprising:
an image generator to generate an image using said position model.

20. The representation system of claim 19, wherein:
said image is a video image presenting the motion of said marker.

21. The representation system of claim 19, wherein:
said image generator receives said position model from an article of removable media.

22. The representation system of claim 19, wherein:
said image generator receives said position model through a network connection.

23. The representation system of claim 19, further comprising:
a display device, connected to said image generator, to display said image.

24. A method of generating a model representing motion of a marker, comprising:
receiving from a marker a marker signal indicating marker information;
storing said marker information;
generating a position model using said stored marker information;
wherein said position model indicates the position of said marker at the time said signal was received.

25. The method of claim 24, further comprising:
sending a request signal to said marker.

26. The method of claim 24, wherein:
said signal is emitted using electromagnetic radiation.

27. The method of claim 26, wherein:
said marker signal is a radio signal.

28. The method of claim 24, wherein:
said marker signal is a magnetic signal.

29. The method of claim 24, wherein:
said marker information includes position information indicating the position of said marker.

30. The method of claim 29, wherein:
said position information is GPS information.

31. The method of claim 24, wherein:
said marker information includes identification information identifying said marker.

32. The method of claim 24, wherein:
receiving said marker signal includes receiving said marker signal at multiple receivers.

33. The method of claim 24, further comprising:
generating reception information based on receiving said marker signal.

34. The method of claim 33, wherein:
said reception information indicates when the signal was received.

35. The method of claim 33, wherein:
said reception information indicates the signal strength of the received signal.

36. The method of claim 33, wherein:
generating said position model includes using said reception information.

37. The method of claim 24, further comprising:
generating an image representing said position model.

38. The method of claim 37, further comprising:
displaying said image.

39. The method of claim 37, wherein:
generating said image includes using input received from a user.

40. The method of claim 39, wherein:
said input includes data indicating what type of image to use to represent an object corresponding to said marker.

41. The method of claim 39, wherein:
said input includes data indicating what camera angle to use to generate said image.

42. The method of claim 24, wherein:
said position model indicates the position of said marker over time using multiple received signals.

43. The method of claim 24, further comprising:
combining said position model with input received from a user.

44. The method of claim 43, wherein:
said input includes data input to an executing video game software application indicating an action taken by said user.

45. A computer program, stored on a tangible storage medium, for use in generating a model representing motion of a marker, the program comprising executable instructions that cause a computer to:
process a marker signal indicating marker information received from a marker;
store said marker information;
generate a position model using said stored marker information;
wherein said position model indicates the position of said marker at the time said signal was received.

46. A system for generating a model representing motion of a marker, comprising:
means for receiving from a marker a marker signal indicating marker information;
means for storing said marker information;
means for generating a position model using said stored marker information;
wherein said position model indicates the position of said marker at the time said signal was received.
